(19) United States
(12) Patent Application Publication
(10) Pub. No.: US 2015/0189714 A1
(43) Pub. Date: Jul. 2, 2015

(54) Sensors with LED Light Sources

(71) Applicant: Endress+Hauser Conducta Inc., Anaheim, CA (US)

(72) Inventors: Ahmed Fathalla, Anaheim, CA (US); Thilo Trapp, Anaheim, CA (US)

(73) Assignee: ENDRESS+HAUSER CONDUCTA INC., Anaheim, CA (US)

(21) Appl. No.: 14/143,619

(22) Filed: Dec. 30, 2013

(51) Int. Cl. H05B 33/08

(52) U.S. Cl. CPC H05B 33/0848; H05B 33/0893

(57) ABSTRACT

An apparatus includes a light emitting diode, a reference detector, and a control unit. The light emitting diode (LED) is configured to emit light along a beam path. The reference detector is configured to generate a signal characterizing an intensity of light emitted from the LED. The control unit coupled to the LED and is configured to selectively vary a driving current applied to the LED in response to the light detected by the reference detector and to maintain a substantially constant intensity of light emitted by the LED. Related apparatus, systems, techniques and articles are also described.

### TECHNICAL FIELD

The subject matter described herein relates to the use of light emitting diodes (LEDs) as light sources for sensors such as ultraviolet absorption spectrometers and fluorescence sensors.

### BACKGROUND

Light sources as mercury vapor lamps, especially those emitting light within the ultraviolet wavelength range, have long been used for various types of sensors including absorption spectrometers and fluorescence sensors. However, mercury vapor lamps suffer from various drawbacks. For example, the intensity output by mercury vapor lamps tends to vary from lamp to lamp and to additionally decrease over time which often requires calibration/recalibration of sensors using such lamps. In addition, mercury vapor lamps can require 25-45 minutes or more to stabilize after such sensors are powered up. Furthermore, the operating life time of a mercury vapor lamp can vary depending on the amount of use which often results in such lamps either being prematurely replaced or replaced after significant intensity degradation has commenced.

### SUMMARY

In one aspect, an apparatus includes a light emitting diode, a reference detector, and a control unit. The light emitting diode (LED) is configured to emit light along a beam path. The reference detector is configured to generate a signal characterizing an intensity of light emitted from the LED. The control unit coupled to the LED and is configured to selectively vary a driving current applied to the LED in response to the light detected by the reference detector and to maintain a substantially constant intensity of light emitted by the LED.

The apparatus can also include a flow cell through which a gas or liquid is passed therethrough. The flow cell can be positioned along a transverse section of the beam path. The apparatus can also include a measurement detector to generate a signal characterizing an intensity of light emitted from the LED along the beam path after passing through the flow cell.

The reference detector can be positioned adjacent to the LED and can be positioned to capture a portion of the light emitted along the beam path.

The driving current can increase as an intensity of light emitted from the LED diminishes.

The control unit can include a drive engine coupled to the LED that generates the driving current. In addition, the control unit can include one or more of a preamplifier to receive the signal from the reference detector, an analog-to-digital converter coupled to an output of the preamplifier, a microcontroller coupled to an output of the analog-to-digital converted for determining whether the driving current requires changing, and a digital-to-analog converter coupled to an output of the microcontroller and coupled to the input of the drive engine.

The control unit can adjust the driving current applied to the LED when the signal generated by the reference detector indicates that an intensity of light emitted by the LED has fallen below a pre-defined lower threshold. In addition, the control unit can adjust the driving current of so that the intensity of light emitted by the LED is above the pre-defined lower threshold and below a pre-defined upper threshold.

In addition, in some variations, the apparatus can include a visual alert element (e.g., an LED, etc.) which can be on an outer surface of the housing. The control unit can initiate an alert to be displayed on the visual alert element when an estimated remaining lifetime of the LED falls below a pre-defined threshold. Such an arrangement enables a technician to replace the LED to minimize service disruption.

In interrelated aspects, methods and computer program products can be provided for use with a sensor comprising a light emitting diode (LED) to emit light along a beam path, a reference detector to generate a signal characterizing an intensity of light emitted from the LED, and a control unit coupled to the LED. The methods and computer program products implement operations including: monitoring the signal generated by the reference detector, determining that the monitored signal indicates that an intensity of light emitted by the LED has fallen below a pre-defined lower threshold or that an intensity of light emitted by the LED exceeds a pre-defined upper threshold, and adjusting the driving current applied to the LED so that an intensity of light emitted by the LED falls within the pre-defined lower threshold and the pre-defined upper threshold as indicated by the monitored signal generated by the reference detector.

Non-transitory computer program products (i.e., physically embodied computer program products) are also described that store instructions, which when executed one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter allows sensors to have more precise light intensity control over the life time of a light source. In addition, the current subject matter allows for more rapid stabilization upon power up as compared to mercury vapor lamps. Furthermore, the current subject matter enables a compact sensor housing as an LED and accompanying control electronics require a significantly smaller footprint as compared to light sources such as mercury vapor lamps. Still further, LEDs require significantly lower power (<30 mA) as compared to mercury vapor lamps (up to 400 mA) which can be particularly helpful in explosion proof environments. Yet further, the current subject matter obviates the need for narrowband interference filters as is required with broadband light sources such as mercury vapor lamps. Also, the current subject matter can compensate for variations in light intensity due to a variety of factors including, but not limited to temperature change, light reflection, ambient light, and decrease of intensity over time.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a block diagram illustrating components of an optical absorption spectrometer;

FIG. 2 is a block diagram illustrating components of a control unit forming part of an optical absorption spectrometer;

FIG. 3 is a diagram illustrating changes in drive current to a light source to compensate for daily temperature fluctuations between 80° C. and 25° C.; and

FIG. 4 is a process flow diagram illustrating maintenance of an intensity of a light source;

Like reference symbols in the various drawings indicate like elements.

### DETAILED DESCRIPTION

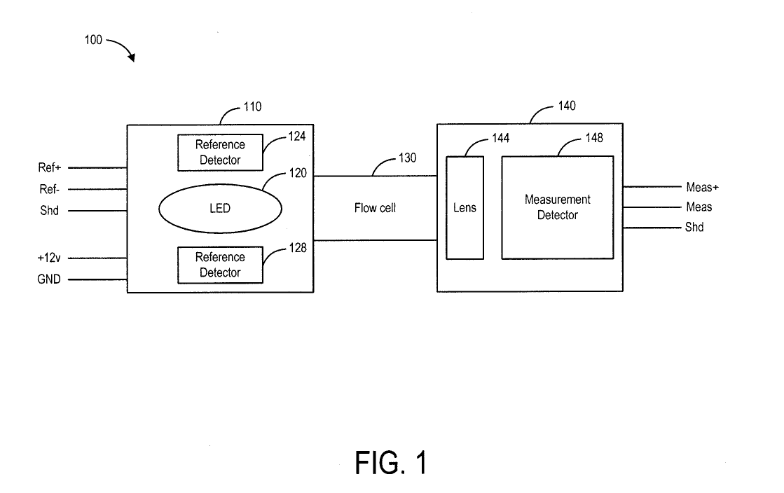

The current subject matter is applicable to any type of optical sensor, and in particular, to optical absorption spectrometers. As one example, FIG. 1 is a diagram illustrating components of a spectrometer 100 that comprises a flow cell 130 disposed intermediate a first housing portion 110 and a second housing portion 140. The first housing portion 110 can include a light emitting diode (LED) 120 emitting light along a beam path extending through the flow cell. The light emitted by the LED 120 can include a wavelength range of interest (for example, within the ultraviolet wavelength range) to identify constituents within a liquid and/or gaseous sample passed through/housed within the flow cell 130. The first housing portion 110 can include a first reference detector 124 (e.g., a photodiode, etc.) and, in some cases, a second reference detector 128 (e.g., a photodiode, etc.). The first reference detector 124 and the second reference detector 128 can each be positioned to either directly capture light emitted by the LED 120 or indirectly capture light emitted by the LED 120 (for example, via one or more intermediate reflective, transmissive elements, or an optical fiber).

The flow cell 130 can form part of a closed path spectrometer and can contain a liquid or gaseous sample to be analyzed. While the term flow cell 130 is used for illustration purposes, it will be appreciated that the flow cell 130 can form part of an open path liquid/gas flow path and that the flow cell, unless otherwise specified, does not need to form a closed housing with an inlet and an outlet.

The second housing portion 140 can be coupled to the flow cell 130 and can be positioned along the beam path such that a measurement detector 148 (e.g., a photodiode, etc.) can capture and quantify light emitted by the LED 120 after passing through the flow cell 130 so that a spectroscopic measurement can be made. In some variations, a lens 144 or other optical element(s) can be disposed between the flow cell 130 and the measurement detector 148 to focus the light emitted by the LED 120. The signals detected by the second reference detector 128 in combination with the measurement detector 148 can, in combination, be used to determine one or more constituents of liquid/gas within and/or passing through the flow cell 130.

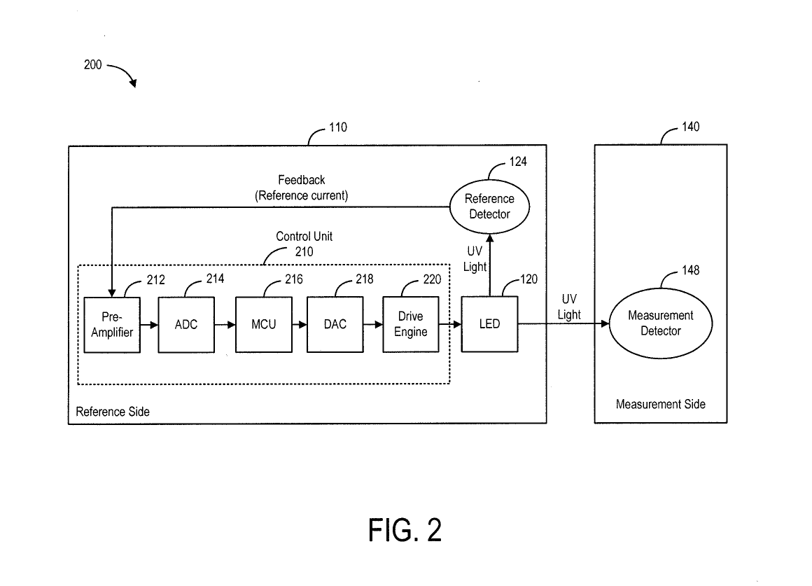

FIG. 2 is a diagram 200 illustrating a control unit 210 that can be disposed within the first housing portion 110 (although the control unit 210 or its components can also be placed outside the first housing portion 110). The control unit 210 can include a preamplifier 212 in electrical contact with the reference detector 124 that can receive and amplify signals generated by the first reference detector 124. The current generated by the first reference detector 124 can be transformed into voltage using a shunt resistor and the output signal can then be buffered using a single stage non-inverting amplifier to isolate the input signal from the output stage of the preamplifier 212. The preamplifier 212 can be a precision amplifier to minimize the leakage current drawn by the input stage of the amplifier which, in turn, minimizes the current error at the input. Buffering the input signal through a single stage non-inverting amplifier will isolate the sensor high impedance input from the amplifier output in order not to load an input stage of an analog-to-digital converter (ADC) 214 which can require a low input impedance to conduct accurate measurements. The amplified signal generated by the preamplifier 212 can, in some variations, be converted from an analog signal into a digital signal by the ADC 214 for use by a microcontroller (MCU) 216. In some cases, a 10 bit ADC can perform digital filtration and calculate the signal level inside the processor.

The MCU 216, as will be described in further detail below, can, based on the signal generated by the first reference detector 124, generate a signal that will ultimately be used to change/maintain an intensity of light emitted by the LED 120. The MCU 216 can be an 8-bit processor that can perform digital filtration and signal level calculation coming out of the ADC 214. The MCU 216 can then control a digital to analog converter (DAC) 218 (e.g., a 12 bit DAC) to control the driving current of the LED 120 based on the calculated input signal from the ADC 214. The MCU 216 can increase the DAC level if the input signal from the ADC 214 is below a pre-defined sensor setting point and it can decrease the DAC level if the input signal from the ADC 214 is higher than a pre-determined sensor setting point in order to close a controlling feedback loop of the LED 120 to maintain intensity at a fixed level. The analog signal coming out from the DAC 218 can then be passed through a driving current engine loop comprising a precession amplifier and npn transistor to drive the amplifier feedback signal that controls the LED 120 current.

Stated differently, the MCU 216 can alter the current applied to the drive engine 220 in order to accommodate for the decrease in light intensity emitted by the LED 120 over time. The driving current applied to the drive engine 220 can initially be at a lowest available level that the LED 120 emits light at an adequate intensity for the measurement detector 148 so that an absorbing analyte in the flow cell 130 can be detected by a drop in light in measured light detected by the measurement detector 148 as compared against measured light detected by the second reference detector 128. The driving current can later be increased by the drive engine 120 (up to a maximum driving current associated with the LED 120) so that the intensity of emitted light remains at a constant/substantially constant level. Such an arrangement is particularly helpful in environments having wide temperature variations as LED intensity decreases with increasing temperatures and vice versa.

In some implementations, an alert can be displayed or otherwise conveyed to a user (e.g., audio cue, an interface on the sensor, etc.) or device (e.g., a signal can be generated, data can be transmitted, etc.) when the driving current approaches the maximum possible driving current. For example, for an LED 120 with a maximum possible driving current of 30 mA, an alert can be generated when the driving current exceeds 29.5 mA.

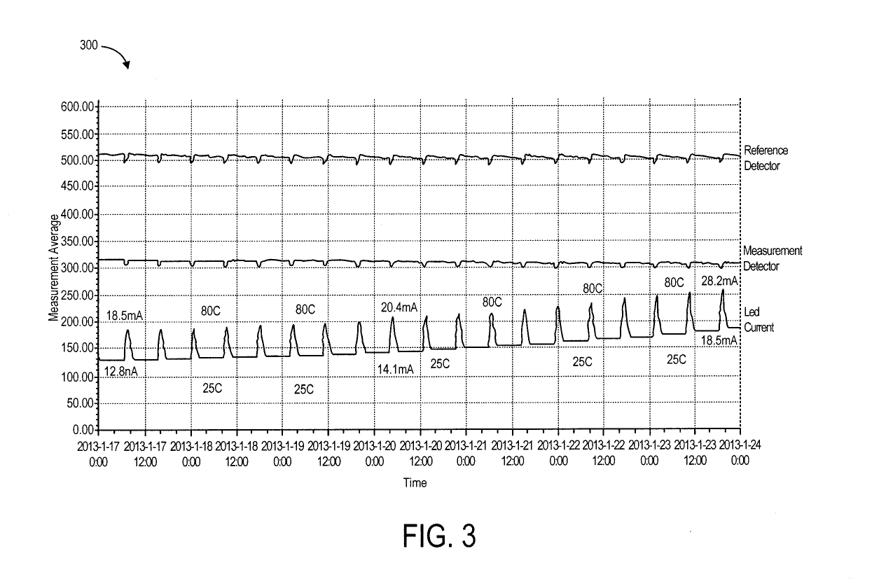

In one demonstration example, the control unit 210 stabilized the reference current of the LED 120 at 100-2200 nA constantly with +/−1% fluctuation. The LED 120 can be driven by the control unit 210 in pulse mode to increase the lifetime of the LED 120 (which is not possible using mercury vapor discharge lamps). Another demonstration example is illustrated in diagram 300 of FIG. 3 which illustrates how the current subject matter can address LED intensity variations due to wide daily swings in temperature (25° C. to 80° C.) or from other factors such as rinsing the flow cell 130 with hot water, flushing the flow cell 130, and the like. As is shown, the baseline LED current ramps up from 12.8 nA to 18.5 mA and the high mark ramps up from 18.5 mA to 28.2 mA while, at the same time, maintaining a substantially uniform intensity as detected by both the reference detector and the measurement detector.

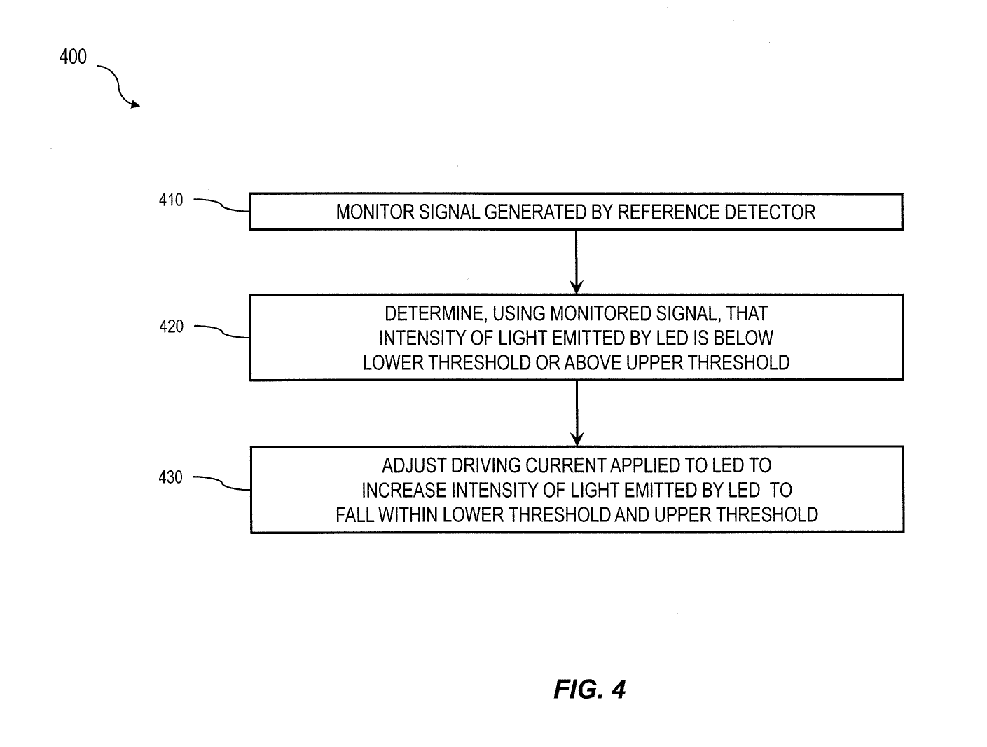

FIG. 4 is a process flow diagram 400 illustrating a method in which, at 410, the signal generated by the reference detector is monitored by the control unit. Thereafter, at 420, the control unit determines that the monitored signal indicates that an intensity of light emitted by the LED has fallen below a pre-defined lower threshold or that an intensity of light emitted by the LED exceeds a pre-defined upper threshold. Thereafter, at 430, the control unit adjusts the driving current applied to the LED so that an intensity of light emitted by the LED falls within the pre-defined lower threshold and the pre-defined upper threshold as indicated by the monitored signal generated by the reference detector.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include ‘implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. An apparatus comprising:
a light emitting diode (LED) to emit light along a beam path;
a reference detector to generate a signal characterizing an intensity of light emitted from the LED; and
a control unit coupled to the LED to selectively vary a driving current applied to the LED in response to the light detected by the reference detector and to maintain a substantially constant intensity of light emitted by the LED.

2. The apparatus of claim 1 further comprising a flow cell through which a gas or liquid is passed therethrough, the flow cell being positioned along a transverse section of the beam path.

3. The apparatus of claim 2 further comprising: a measurement detector to generate a signal characterizing an intensity of light emitted from the LED along the beam path after passing through the flow cell.

4. The apparatus of claim 1, wherein the reference detector is positioned to directly or indirectly capture a portion of the light emitted along the beam path.

5. The apparatus of claim 1, wherein the driving current increases as an intensity of light emitted from the LED diminishes.

6. The apparatus of claim 1, wherein the control unit comprises: a drive engine coupled to the LED that generates the driving current.

7. The apparatus of claim 6, wherein the control unit further comprises: a preamplifier to receive the signal from the reference detector, an analog-to-digital converter coupled to an output of the preamplifier, a microcontroller coupled to an output of the analog-to-digital converted for determining whether the driving current requires changing, and a digital-to-analog converter coupled to an output of the microcontroller and coupled to the input of the drive engine.

8. The apparatus of claim 1, wherein the control unit adjusts the driving current applied to the LED when the signal generated by the reference detector indicates that an intensity of light emitted by the LED has fallen below a pre-defined lower threshold.

9. The apparatus of claim 8, wherein the control unit further adjusts the driving current so that the intensity of light emitted by the LED is above the pre-defined lower threshold and below a pre-defined upper threshold.

10. The apparatus of claim 1, wherein the control unit initiates an alert when an estimated remaining lifetime of the LED falls below a pre-defined threshold.

11. A method for use with a sensor comprising a light emitting diode (LED) to emit light along a beam path, a reference detector to generate a signal characterizing an intensity of light emitted from the LED, and a control unit coupled to the LED, the method comprising:
monitoring the signal generated by the reference detector;
determining that the monitored signal indicates that an intensity of light emitted by the LED has fallen below a pre-defined lower threshold or that an intensity of light emitted by the LED exceeds a pre-defined upper threshold; and
adjusting the driving current applied to the LED so that an intensity of light emitted by the LED falls within the pre-defined lower threshold and the pre-defined upper threshold as indicated by the monitored signal generated by the reference detector.

12. The method of claim 11, wherein the sensor further comprises a flow cell through which a gas or liquid is passed therethrough, the flow cell being positioned along a transverse section of the beam path.

13. The method of claim 12, wherein the sensor further comprises: a measurement detector to generate a signal characterizing an intensity of light emitted from the LED along the beam path after passing through the flow cell.

14. The method of claim 11, wherein the reference detector is positioned to directly or indirectly capture a portion of the light emitted along the beam path.

15. The method of claim 11, wherein the control unit comprises: a drive engine coupled to the LED that generates the driving current.

16. The method of claim 15, wherein the control unit further comprises: a preamplifier to receive the signal from the reference detector, an analog-to-digital converter coupled to an output of the preamplifier, a microcontroller coupled to an output of the analog-to-digital converted for determining whether the driving current requires changing, and a digital-to-analog converter coupled to an output of the microcontroller and coupled to the input of the drive engine.

17. The method of claim 11, further comprising:
determining that an estimated remaining lifetime of the LED has fallen below a pre-defined threshold; and
initiating an alert indicating that the LED requires replacement or will soon require replacement.

18. A non-transitory computer program product for use with a sensor comprising a light emitting diode (LED) to emit light along a beam path, a reference detector to generate a signal characterizing an intensity of light emitted from the LED, and a control unit coupled to the LED, the computer program product storing instructions, which when executed by at least one programmable data processors, result in operations comprising:
monitoring the signal generated by the reference detector;
determining that the monitored signal indicates that an intensity of light emitted by the LED has fallen below a pre-defined lower threshold or that an intensity of light emitted by the LED exceeds a pre-defined upper threshold; and
adjusting the driving current applied to the LED so that an intensity of light emitted by the LED falls within the pre-defined lower threshold and the pre-defined upper threshold as indicated by the monitored signal generated by the reference detector.

19. The computer program product of claim 18, wherein the control unit comprises: a drive engine coupled to the LED that generates the driving current, a preamplifier to receive the signal from the reference detector, an analog-to-digital converter coupled to an output of the preamplifier, a microcontroller coupled to an output of the analog-to-digital converted for determining whether the driving current requires changing, and a digital-to-analog converter coupled to an output of the microcontroller and coupled to the input of the drive engine.

20. The computer program product of claim 19, wherein the operations further comprise:
determining that an estimated remaining lifetime of the LED has fallen below a pre-defined threshold; and
initiating an alert indicating that the LED requires replacement or will soon require replacement.
